(19) United States
(12) Patent Application Publication
(10) Pub. No.: US 2007/0077966 A1
(43) Pub. Date: Apr. 5, 2007

(54) Subscriber identity apparatus, communication terminal and communication system and method

(75) Inventor: Shibi Huang, Shenzhen (CN)

Correspondence Address: MERCHANT & GOULD PC, P.O. BOX 2903, MINNEAPOLIS, MN, 55402-0903, US

(73) Assignee: Huawei Technologies Co., Ltd., Shenzhen (CN)

(21) Appl. No.: 11/540,402

(22) Filed: Sep. 29, 2006

(30) Foreign Application Priority Data
Sep. 30, 2005 (CN) 200510107409.4

(51) Int. Cl. H04B 1/38

(52) U.S. Cl. 455/558; 455/411

(57) ABSTRACT

The present invention proposes a wireless subscriber identity module, a communication terminal using the subscriber identity module, a method for attaching the subscriber identity apparatus to the communication terminal and a method for controlling the communication by using the communication terminal. The subscriber identity apparatus includes: a subscriber identity module, a wireless network interface module and a central processing unit. The communication terminal includes a central processor, a first interface module for accessing the communication service network and a second interface module for accessing the local wireless network system. The central processor obtains subscriber identity information through the second interface module, attaches a subscriber corresponding to the identity information and makes the corresponding subscriber communicate with the communication service network through the first interface module.

### FIELD OF THE INVENTION

The present invention relates to communication technologies, and more particularly to a subscriber identity apparatus, a communication terminal, and a communication system and method.

### BACKGROUND OF THE INVENTION

The Subscriber Identity Module (SIM), also called the Subscriber Identity Apparatus, is a component for identifying the subscriber identity. The application system may determine the subscriber identity by authenticating the unique subscriber identity information contained in the SIM. The SIM may also store the subscriber related information such as the subscriber number, short message, telephone book, key, cryptographic algorithm etc.

In the communication system, the communication service network needs to authenticate the subscriber identity. Only those who have been successfully authenticated may access the communication service network and to obtain the service permission. For example, in the 2G mobile communications, the GSM (Global System for Mobile Communications) network system performs the authentication by the subscriber identity information stored in the SIM (Subscriber Identity Module) card of the mobile terminal and only those which have been successfully authenticated may access the GSM network. The subscriber needs to input the authentication information such as the subscriber name, password and etc, and may access the Internet after he is successfully authenticated by the access system. In the communication system, the subscriber identity is used for charging besides for authentication, the communication service fee of the subscriber is associated with the subscriber identity and the service usage reckoning related to the subscriber identity is outputted.

A traditional subscriber identity authentication method in the communication system in the prior art is to attach the subscriber identity and the telephone line and make the telephone number configured for the telephone line correspond to the subscriber identity in the traditional PSTN (Public Switch Telephone Network).

For the fixed line terminal in the future fixed communication network, if the method of attaching the subscriber identity of PSTN terminal and the network SAP (Service Access Point) is continuously used, it will bring forward many problems in the security and mobility limitation. Since the identity of the subscriber using the fixed line terminal may not be authenticated, there is possibilities that some other illegal subscribers may use the fixed line terminal illegally, for example, for the office telephone in the fixed PSTN, some illegal subscriber may make international calls by using other's fixed telephone. Meanwhile, the mobility of the subscriber may be limited greatly, for example, when the subscriber is on business in another city, the incoming call of the subscriber is still routed to the registered fixed line terminal while maynot be routed to the fixed terminal, such as the telephone in the hotel and the office, in his current city, and such function may only be realized by configuring a complex service server in the network and setting data in the service server in time. When the subscriber moves to another place and uses another fixed line terminal, the communication fee may only be pertained to the corresponding fixed line terminal and maynot be pertained to the subscriber.

Another subscriber identity authentication method in the communication system in the prior art is realized on the communication terminals through the account number and the password inputted by the subscriber, which is a common identity authentication method based on the H.323, Call Server and etc in the fixed communication network. As shown in FIG. 1, the subscriber inputs the authentication information such as the account number and the password to the fixed line terminal, and the fixed line terminal establishes the authentication and authorization procedure according to the account number. The specific authentication procedure may adopt the Challenge, Response or CA authentication method so as to avoid transmitting the plaintext of the account and password on network and to improve the authentication security.

For some public fixed line terminals shared by subscribers, a subscriber may be identified by inputting the subscriber account number for identifying the subscriber identity such as the card number and the password etc. However, such operations need to be performed every time the subscriber uses the terminal, which is extraordinarily inconvenient. Moreover, the security of the card number and the password maynot be guaranteed, and the account number is easily to be stolen by illegal subscribers. Meanwhile, this method may only be used to identify the identity of the subscriber who initiates the communication and since a plurality of subscribers share the same telephone number, this method maynot identify the identity of the calling subscriber and maynot use different indication tones to notify and identify different calling subscriber.

Another subscriber identity authentication method in the communication system in the prior art realizes the subscriber identity authentication of the network by the information, such as the subscriber identity, algorithm and key, stored in the subscriber identity module inserted to or set in the IC card of the communication terminal. For example, the subscriber uses SIM card in the 2G network and uses the USIM (Universal Subscriber Identity Module) card in the 3G network as the SIM to uniquely identify the subscriber and to realize the corresponding authentication, authorization and charging, which realizes the separation of the subscriber identity module and the terminal in the mobile communication. As shown in FIG. 2, the authentication of the subscriber identity by the network is realized by the information, such as the subscriber identity, algorithm and key, stored in the subscriber identity module inserted to or set in the IC card of the communication terminal. This method includes the SIM card authentication mode in the 2G GSM network, the USIM card authentication mode in the 3G mobile network and the authentication mode of other embedded cards in the CDMA, PHS and other systems. The mobile terminal obtains the subscriber identity, algorithm and key stored in the IC card, which is inserted or embedded in the mobile terminal, by IC card's reading and writing machine, establishes the authentication and authorization procedure with the communication service network system through the authentication mechanisms such as the AKA (Authentication and Key Agreement). After being authenticated, the mobile terminal may access the communication service network system and enjoy the subscribed communication service.

In the 2G/3G mobile communication system, although the technology to separate the mobile terminal and the subscriber identity module is realized, the SIM or USIM card adopts the intelligent IC card standard in ISO/IEC 7816, the IC card needs to be inserted in the mobile terminal when being in use and the data interact between the mobile terminal and the IC card through the IC card's reading and writing machine in the mobile terminal. Therefore, limited by the IC card's reading and writing machine's physical architecture, one SIM or one USIM IC card may only be attached with one mobile terminal during certain time. If a subscriber has a plurality of mobile terminals, different IC cards for identifying the subscriber identity should be applied for the mobile terminals which may not share one subscriber identity module. Accordingly, the service network will generate different billing for different subscriber identity modules of one subscriber, which brings great inconvenience for both the operator and the subscriber and costs a lot in human resources and expenses.

### SUMMARY OF THE INVENTION

The present invention provides a subscriber identity apparatus, a communication terminal using the subscriber identity apparatus, a communication system, a method for attaching the subscriber identity apparatus to the communication terminal and a method for controlling the communication by using the communication terminal.

A subscriber identity apparatus is used for the communication terminal, which accesses the local wireless network system.

The subscriber identity apparatus includes: a subscriber identity module, a wireless network interface module and a central processing unit.

The subscriber identity module is used to store subscriber identity information;

The wireless network interface module is used to access the local wireless network system.

The central processing unit is connected between the subscriber identity module and the wireless network interface module, and is used to control the subscriber identity apparatus to establish communication through the wireless network system with the communication terminal and send the identity information to the communication terminal.

The present invention further provides a communication terminal, which includes a central processor and a first interface module for accessing a communication service network.

The second interface module is used to access a local wireless network system, and the central processor obtains subscriber identity information through the second interface module, attaches a subscriber corresponding to the identity information and makes the corresponding subscriber communicate with the communication service network through the first interface module and realize communication.

The present invention further provides a communication system including a communication service network, at least one communication terminal and at least one subscriber identity apparatus. The communication system further includes a local wireless network system for realizing communication between the communication terminal and the subscriber identity apparatus. The communication terminal obtains subscriber identity information from the subscriber identity apparatus, attaches a subscriber corresponding to the identity information, and makes the corresponding subscriber access the communication service network and realize communication.

The present invention further provides a method for attaching a subscriber identity apparatus to a communication terminal. The subscriber identity apparatus and the communication terminal are connected with a local wireless network system respectively. The subscriber identity apparatus stores the subscriber identity information and the method includes the steps of:

establishing a communication transmission link between the subscriber identity apparatus and the communication terminal through the local wireless network system;

obtaining the subscriber identity information through the communication transmission link and setting a subscriber corresponding to the subscriber identity information to the attached status by the communication terminal.

The present invention further provides a communication control method of the communication terminal. The communication terminal obtains the subscriber identity information respectively from the subscriber identity apparatus through the local wireless network system and the subscriber corresponding to the subscriber identity information is attached. The control method includes the following steps:

ending a registration request by the communication terminal, which carries the subscriber identity information, communication identity information corresponding to the subscriber and allocated by the communication service network and the communication terminal′ second address information allocated by the communication service network;

correspondingly recording the subscriber identity information, the communication identity information corresponding to the subscriber and the second address information of the communication terminal, and processing communication of the subscriber corresponding to the subscriber identity information according to the correspondence between the communication identity information of the subscriber and the second address information of the communication terminal by the communication service network.

The present invention solves the problem that one Subscriber Identity Module may only be attached to one terminal and realizes that one Subscriber Identity Module may be attached to a plurality of terminals at the same time or in time division. The present invention supports that a plurality of terminals of one subscriber may share the same Subscriber Identity Module, which simplifies the network management and operation and reduces the human resource and expenses. The present invention solves the problem that one terminal may only be attached to one Subscriber Identity Module and realizes that one terminal may be attached to a plurality of SIMs at the same time so that one terminal may be shared by a plurality of subscribers simultaneously. The present invention solves the problem that when the subscriber updates the terminal or changes the current terminal after movement, the IC card should be manually inserted or pulled out for the Subscriber Identity Module in the IC card mode.

The present invention is likely to have one or more than one of the following advantages:

1. the present invention realizes that one subscriber identity module may be attached to a plurality of communication terminals at the same time or in time division and support that a plurality of terminals of one subscriber may share the same subscriber identity module so as to simplify the network management and operation and to reduce the human resource and expenses.

2. the present invention realizes that one communication terminal may be attached to a plurality of subscriber identity modules at the same time, and supports that a plurality of subscribers may share the same terminal simultaneously and a plurality of family members may share the same terminal.

3. the present invention solves the problem that when the subscriber updates the terminal or changes the current terminal after movement, the IC card should be manually inserted or pulled out for the SIM in the IC card mode. The present invention adopts the wireless subscriber identity module to realize the automatic attaching of the terminal to the subscriber identity module, which avoids manual operations.

4. the present invention realizes the separation of the fixed line communication terminal and the subscriber identity module, and supports the subscriber to use the wireless subscriber identity module for registering and attaching different fixed line terminals after movement, which greatly improves the mobility service experience of the subscriber.

5. the present invention enables the subscriber to attach terminals at different place and of different type to a unique wireless subscriber identity module, dedicates communication fees of different terminals to the same subscriber, which brings great convenience to both the operator and the subscriber. Meanwhile, the present invention reduces the waste of human resources and expenses compared with the mode of charging for terminal or charging for a plurality of subscriber identity modules of the same subscriber.

6. the present invention enables the subscriber to attach terminals at different place and of different type to a unique wireless subscriber identity module, to download the interface, operation manner and indication information from the subscriber home database to different terminals according to the subscriber identity module, which guarantees that the experience mode on different terminals for the same subscriber will not be changed.

7. The wireless subscriber identity module as a unique identity of the subscriber accompanied with the authentication mechanism for providing security may be applied in the fields, such as the commerce, security etc, besides communication fields and has a broad application prospect.

### BRIEF DESCRIPTION OF THE DRAWING

FIG. 1 is a schematic diagram showing the procedure that a communication terminal establishing the authentication and authorization process with the communication service network system according to the authentication information when a traditional subscriber inputs the authentication information such as the account number and the password into the communication terminal;

FIG. 2 is a schematic diagram showing the procedure that a traditional subscriber uses the SIM card to uniquely identify the subscriber and realizes the corresponding authentication;

FIG. 3 is a schematic diagram showing the architecture of a communication system according to an embodiment of the present invention;

FIG. 4 is a schematic diagram showing the architecture of a subscriber identity apparatus according to an embodiment of the present invention;

FIG. 5 is a schematic diagram showing the architecture of a communication terminal according to an embodiment of the present invention.

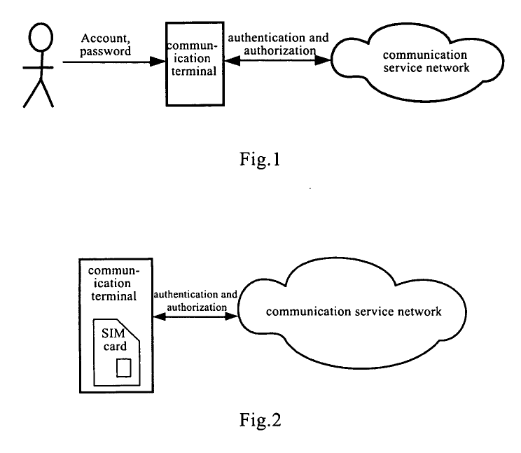

### DETAILED DESCRIPTION OF THE INVENTION

The present invention provides a subscriber identity apparatus and method for satisfying the above requirements. The communication system according to the present invention realizes the separation of the subscriber identity apparatus and the network communication terminal, supports the flexible attaching mode of the subscriber identity apparatus and the network terminal, i.e. supports that a plurality of terminals may be attached to the same subscriber identity apparatus at the same time or in time division, and also supports that a plurality of subscriber identity apparatuses may be attached to one terminal. Therefore, the communication system realizes that each subscriber may use a plurality of network terminals with only one subscriber identity apparatus while the same terminal may be shared by a plurality of subscribers, which has an important application forecast.

The main ideas of the present invention are:

1. The communication between the subscriber identity apparatus and the communication terminal is realized through the wireless interface, which solves the problem that the subscriber identity apparatus in IC card mechanism needs to physically contact the terminal, realizes the physics architecture separation of the subscriber identity apparatus and the communication terminal, and supports the multiple-to-multiple attaching possibility of the communication terminals and the subscriber identity apparatuses in the physics architecture.

2. By improving the ability of the current terminal, the present invention may support that a plurality of subscriber identity apparatuses may be attached to one terminal, support the subscriber identity apparatuses able to conveniently choose to initiate a session, and support the session identification of different subscribers through the subscriber identity information such as the serial number carried in the session signaling from the network and support the notification messages transmission, which may differentiate the subscribers and are used to notify the users, for example, different ring tones are used to notify different subscribers.

3. By improving the ability of the current communication service network system, the present invention may support that one subscriber identity apparatus may be attached to a plurality of communication terminals at the same time, and support that one terminal may be attached to a plurality of subscriber identity apparatuses.

4. When a wireless link exists between the subscriber identity apparatus and the communication terminal, the present invention automatically realizes the attaching, and solves the problem that the attaching process needs to be manually performed for the subscriber identity apparatus and the communication terminal.

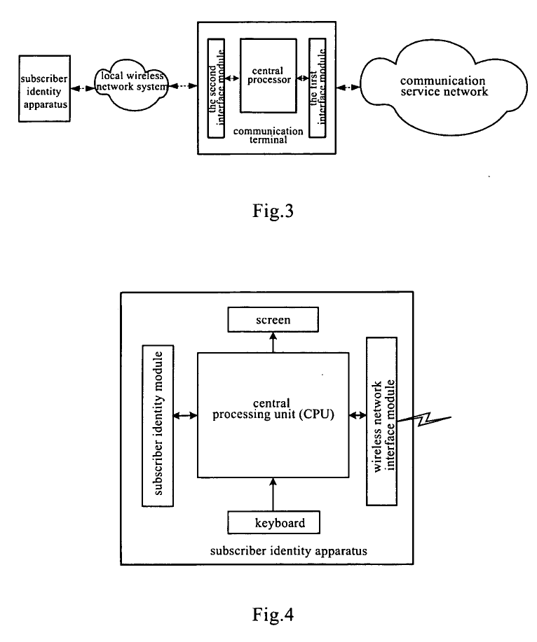

FIG. 3 is the schematic diagram showing the architecture of the communication system according to an embodiment of the present invention. The communication system includes a communication service network, a local wireless network system, at least one communication terminal and at least one subscriber identity apparatus.

1. the subscriber identity apparatus:

As shown in FIG. 4, the subscriber identity apparatus is a kind of subscriber identity apparatus using the wireless interface, which includes a subscriber identity module, a wireless network interface module, a central processing unit, a keyboard for inputting the control command and a screen for displaying the status information.

The subscriber identity module is used to store the subscriber identity information.

The wireless network interface module is used to connect to the local wireless network system.

The central processing unit is connected between the subscriber identity module and the wireless network interface module, and is used to realize the communication by the local wireless network system and the communication terminal and to send the identity information to the communication terminal.

The communication terminal with the wireless interface may access the information such as the subscriber's unique identity, key, cryptographic algorithm etc. in the subscriber identity apparatus through the local wireless network system.

In order to fully inherit the subscriber identity apparatus technology in the current mobile network, the subscriber identity module may be extendably added with a local wireless network interface and a corresponding input/output/communication processing function on the basis of the former SIM, USIM, ISIM (IP Multimedia Services Identity Module) defined by 3GPP, so that the subscriber identity module may have a local wireless network interface and the communication terminal may communicate with the subscriber identity apparatus through the local wireless network system. Therefore, the ID-1 SIM and Plug-in SIM generally used in the current mobile network may be continually used in the subscriber identity apparatus.

The communication terminal may be directly used as a subscriber identity apparatus. The subscriber identity information in the ID-1 SIM or Plug-in SIM of the mobile terminal may be provided to other communication terminals for use through the local wireless network system by adding a local wireless network interface to the mobile terminal with the ID-1 SIM or Plug-in SIM.

For the function of the synchronously initiated access from a plurality of communication terminals to a subscriber identity apparatus supported by the subscriber identity apparatus, a plurality of subscribers may be attached to different communication terminals respectively.

2. the communication terminal with a local wireless network interface

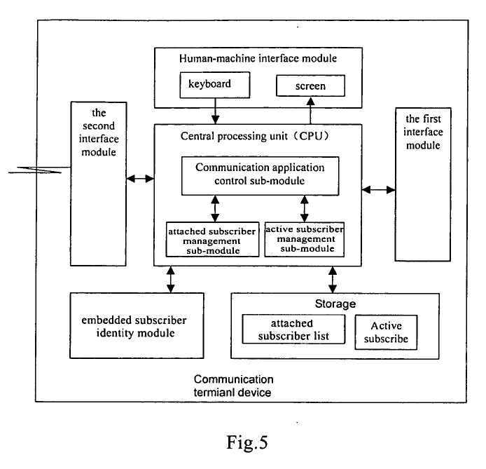

As FIG. 5 shows the communication terminal using the method of the present invention has both a local wireless network interface and a current communication service network interface and has a function of communicating with the subscriber identity apparatus through the local wireless network interface.

The communication terminal may access different kinds of fixed and mobile communication service network systems through the communication service network interface, and supports the access technologies of GSM, GPRS, EDGE, 802.11, TDMA, FDMA, CDMA, WCDMA, Bluetooth, WiMAX, traditional analog telephone line, xDSL, Ethernet or point-to-point dedicated line and etc.

The communication terminal may be attached to a plurality of subscriber identity apparatuses at the same time, may be used by a plurality of subscribers at the same time and may provide different use interfaces and tones or lights for different subscribers. One of the implementation manners is that the registered subscriber subscribes the use interface and different tones or lights from the operator. The operator considers the subscribed information as the configuration parameter or Java program and stores the identity information corresponding to the subscriber in the subscriber home databases such as the HLR or HSS. The communication terminal may provide different human-machine interfaces for different subscribers by downloading the terminal configuration parameter or Java program from the subscriber home databases such as the HLR or HSS. Another implementation manner is that the subscribers sharing the same communication terminal set human-machine interfaces corresponding to themselves on the communication terminal respectively.

The communication terminal includes a communication application control sub-module, wherein the communication application control sub-module is connected with an attached subscriber management sub-module and an active subscriber management sub-module, which are responsible for the management of the attached subscriber and that of the active subscriber respectively.

The communication terminal further includes a storage module which stores the list of the successfully attached subscribers in the current terminal and the information of the subscribers in the active status. The attached subscriber list stores the relative information of the corresponding subscribers such as the subscriber identity information, subscriber communication identity information and the information that whether the subscriber has been successfully registered in the service network system.

One example of the subscriber information stored in the attached subscriber list is shown in Table 1:

TABLE 1
list of the attached subscribers

| | subscriber | | Name of | Code of | |
|---|---|---|---|---|---|
| | communication | subscriber | the | the | |
| | identity | identity | attached | indication | |
| Number | information | information | subscriber | tone | . . . |
| 1 | subscriber | subscriber | Zhang | 2 | . . . |
| | communication | identity 1 | Cheng | | |
| | identity 1 | | | | |
| | (1391*****28) | | | | |
| 2 | subscriber | subscriber | Liu Ming | 4 | . . . |
| | communication | identity 2 | | | |
| | identity 2 | | | | |
| | (075528780808) | | | | |
| 3 | . . . | | . . . | . . . | . . . |

The communication terminal not only supports the subscriber identity apparatus connected through the local wireless network system, but also supports the subscriber identity identification mechanisms such as the embedded or inserted SIM, USIM card, or soft SIM, subscriber account number, line authentication and etc to identifying the user of the terminals. The communication terminal supports one of above identity identification mechanisms or their combinations.

3. the local wireless network system

The local wireless network system realizes the communication connection between the communication terminal and the subscriber identity apparatus through the second interface module of the communication terminal and the wireless network interface module of the subscriber identity apparatus.

The communication terminal and the subscriber identity apparatus perform the identity authentication attaching for a plurality of subscriber identities on communication terminals after connected to the local wireless network system.

The local wireless network system may be a local network which adopts the wireless technologies such as the WiFi (802.11), Bluetooth, 27 Mhz or 900 Mhz. Accordingly, the second interface module of the communication terminal and the wireless network interface module of the subscriber identity apparatus may also adopt the interface modules of WiFi, Bluetooth, 27 Mhz or 900 Mhz.

4. the communication service network system

The network system providing the communication service for the subscribers includes the 2G GSM, CDMA, 3G WCDMA, CDMA 2000 network in the mobile fields and the PSTN/ISDN, H.323, SIP, the network based on the soft switch and the network based on the separated control, carrier and service of IMS in the fixed line fields.

The communication service network system supports that a plurality of subscriber identity apparatuses may be attached to the same communication terminal and supports the corresponding operations such as the subscriber registration authentication, subscriber session routing, subscriber service accounting and etc. The communication service network system supports that a subscriber identity apparatus may be attached to a plurality of communication terminals simultaneously and supports the corresponding operations such as the subscriber registration authentication, subscriber session routing, subscriber service accounting and etc.

After the subscriber is registered and authenticated, the communication service network system needs to register the address information of the terminal currently attached by the registered subscriber and the communication identity information of the corresponding subscriber. If the registered subscriber is attached to a plurality of communication terminals simultaneously, accordingly, there are pieces of registered terminal address information and communication identity information of the corresponding subscriber. When the communication service network system processes the incoming call to the subscriber according to his communication identity information, if the communication identities corresponding to the subscriber are the same on a plurality of communication terminals, the call may be routed to all the communication terminals to which the subscriber is attached; and if the communication identities corresponding to the subscriber are different on a plurality of communication terminals, the call will be routed to the communication terminal corresponding to the communication identity information.

The method for attaching the subscriber identity apparatus to the communication terminal according to an embodiment of the present invention will be described in detail with reference to the subscriber identity apparatus, the communication terminal using the subscriber identity apparatus and the communication system.

A subscriber corresponding to a subscriber identity apparatus with a wireless interface needs to be attached to the communication terminal and successfully register to the communication service network system connected with the communication terminal before he is able to initiate a call or receive a call. The attaching process includes the following steps.

Step 1. The subscriber identity apparatus with a wireless interface detects a communication terminal with a local wireless network interface through the local wireless network system and establishes the communication transmission link.

In the detection mechanism, after the subscriber identity apparatus with a wireless interface enters a region covered by a new local wireless network system, it initiatively initiates a broadcast inquiry and then the communication terminal responds to this inquiry. The process specifically includes:

step a1: the subscriber identity apparatus sends a broadcast inquiry message carrying the subscriber identity apparatus address information through the local wireless network system.

step a2: the communication terminal receives the broadcast inquiry message through the local wireless network system, and returns a inquiry response message carrying the first address information of the communication terminal to the subscriber identity apparatus according to the subscriber identity apparatus address information, in which the first address information is allocated by the local wireless network system.

step a3: the subscriber identity apparatus establishes a communication transmission link with the communication terminal through the local wireless network system according to the first address information.

Alternatively, after the communication terminal with a local network wireless interface enters a region covered by a new local wireless network system, it initiatively broadcasts its address information to the subscriber identity apparatus with a wireless interface. The process specifically includes:

step b1: the communication terminal sends a broadcast inquiry message carrying the communication terminal address information through the local wireless network system.

step b2: the subscriber identity apparatus receives the broadcast inquiry message through the local wireless network system, and returns a inquiry response message carrying the subscriber identity apparatus address information to the communication terminal according to the first address information.

step b3: the communication terminal establishes a communication transmission link with the subscriber identity apparatus through the local wireless network system according to the subscriber identity apparatus address information.

Step 2: In order to guarantee the terminal will not be used by illegal subscribers, the communication terminal with a local network wireless interface may authenticate the subscriber identity apparatus with a wireless interface.

The authentication method may be the shared key authentication. When the subscriber identity apparatus is attached to a communication terminal for the first time, the shared key of the corresponding communication terminal needs to be inputted into the subscriber identity apparatus. If the shared key of the corresponding terminal has been already stored in the subscriber identity module, the automatic authentication may be started, which avoids the requirements to input the shared key again. In the subscriber identity apparatus with a wireless interface, the subscriber may add, delete and modify the shared key of the corresponding terminal.

Step 3: A reliable communication transmission link is established between the subscriber identity apparatus with a wireless interface and the communication terminal with a local network wireless interface through the local wireless network system.

After the communication transmission link between the subscriber identity apparatus and the communication terminal interrupts, which is caused by the reasons that the subscriber identity apparatus or the communication terminal leaves the region covered by the local wireless network system due to the the physical address change or the local wireless network system fails, the subscriber identity apparatus needs to be attached to the communication terminal again through step 1.

Step 4: After the subscriber identity apparatus with a wireless interface is successfully attached to the communication terminal with a local network wireless interface and the reliable communication transmission link is established, the communication terminal initiates a registration authentication process to the communication service network system for the subscriber corresponding to the attached subscriber identity apparatus.

The subscriber identity apparatus establishes the communication transmission link with two or more communication terminals at the same time or in time division, so that the two or more communication terminals obtain the subscriber identity information respectively, and the subscriber corresponding to the subscriber identity information is attached to two or more communication terminals simultaneously.

The communication terminal establishes the communication transmission link with two or more subscriber identity apparatuses at the same time or in time division, so that the two or more subscriber identity apparatuses obtain the subscriber identity information respectively from each subscriber identity apparatus and the subscriber corresponding to two or more subscriber identity apparatuses is attached to the communication terminal simultaneously.

The communication terminal supports one or more subscriber identity identification mechanisms such as the subscriber identity apparatus with a wireless interface, embedded or inserted SIM, USIM card, soft SIM, subscriber account number or line authentication etc. The communication terminal will select a default subscriber as use active status. Until the active status is changed to another subscriber, the session operations initiated from the terminal pertain to the default subscriber. If a subscriber corresponding to the subscriber identity apparatus with a wireless interface is not the one corresponding to the current use active status on this terminal, the terminal needs to perform the use active operations before a session is initiated by using the terminal, and the session initiation operations of a communication terminal in a period of a particular subscriber's use active status are dedicated to the subscriber identity apparatus that initiates the use activating operation. The terminal user may select some attached subscriber as a use active subscriber through the terminal interface operations. In order to avoid some illegal subscriber uses the terminal, the selection of the active subscriber by the terminal may adopt a certain authentication manner. Only those subscribers who have passed the authentication may perform the use active operation of specified subscribers. The authentication manner may require the subscriber to input the key to confirm the subscriber identity, and the key information on the terminal may be obtained when the subscriber is attached or registered to the network.

The initiating method through the subscriber identity apparatus with a wireless interface includes the steps of:

Step A: the subscriber initiates the active operation to the attached communication terminal through the wireless communication link by the subscriber identity apparatus with a wireless interface.

The specific operation may be that the subscriber tabs some hot key on the subscriber identity apparatus and triggers the use activating operation for the attached communication terminal. For simplifying the subscriber operation, the subscriber may implement the use activating operation for all the attached communication terminals of the subscriber identity apparatus, and practically, the subscriber may select a certain attached communication terminal and implement the use activating operation.

Step B: after receiving a use active operation command from some subscriber identity apparatus with a wireless interface, the communication terminal with a local wireless network interface enters the subscriber use activated status corresponding to the subscriber identity apparatus. In such case, all the initiated sessions belong to the subscriber corresponding to the subscriber identity apparatus.

The communication terminal may provide different subscribers with different use interfaces according to the terminal configuration data downloaded from the subscriber home database in the communication service network for their use activated statuses, for example, the communication terminal displays the information such as the current subscriber name to differentiate different subscribers. When a specific subscriber identity apparatus activates the terminal to enter the use activated status of a specific subscriber, if it does not initiate session operations during a certain period, it will be switched to the use active status of the default subscriber of the communication terminal. When a specific subscriber identity apparatus activates the terminal to enter use activated status of the specific subscriber and is not in the use status, if there is a new subscriber identity apparatus initiating the use activating operation, the subscriber identity apparatus which initiates the use activating operation latterly will have priority, and the terminal enters the use activated status of the subscriber managed by the subscriber identity apparatus which initiates the use activating operation latterly.

The communication control method with the communication terminal will be described in detail with reference to the method for attaching the subscriber identity apparatus to the communication terminal according to an embodiment of the present invention.

When the communication terminal obtains the subscriber identity information from the subscriber identity apparatus and attaches the subscriber corresponding to the subscriber identity information through the local wireless network system, it may support that one or more subscribers share the communication terminal and control the communication by the communication terminal. The process is as follows:

Step 1′: the communication terminal sends a registration request to the communication service network, which carries the subscriber identity information, the communication identity information corresponding to the subscriber allocated by the communication service network and the second address information of the communication terminal allocated by the communication service network.

Step 2′: the communication service network records the subscriber identity information, the communication identity information corresponding to the subscriber and the second address information of the communication terminal correspondingly, and processes the communication of the subscriber corresponding to the subscriber identity information according to the correspondence between the communication identity information corresponding to the subscriber and the second address information of the communication terminal.

When the communication terminal receives a session request from the network, it matches the corresponding called subscriber and notifies the subscriber. The specific process is as follows:

Step 21′: the communication terminal obtains the called subscriber's identity according to the communication identity information or the identity information of the called subscriber in the session request signaling from the network.

When the subscriber corresponding to a subscriber identity is attached to two or more communication terminals simultaneously, the communication service network records the second address information of the two or more communication terminals and the communication identity information corresponding to the subscriber according to communication identity information of the subscriber; and the communication service network connects the incoming call carrying the subscriber's communication identity information to the corresponding communication terminal according to the communication identity information of the called subscriber whose session is ended by the subscriber and the second address information of the communication terminal.

When the subscriber corresponding to the subscriber identity information has the same communication identity information on two or more communication terminals, the communication service network connects the incoming call carrying the subscriber's communication identity information to a plurality of corresponding communication terminals according to the communication identity information of called subscriber whose session is ended by the subscriber and the second address information of a plurality of corresponding communication terminals.

When two or more subscribers corresponding to the above subscriber identity information are attached to the same communication terminal simultaneously, before the outgoing call is initiated, one of the attached subscribers is set to be the active subscriber and then the outgoing call is initiated, wherein the outgoing call carries the communication identity information of the active subscriber.

The outgoing call represents a call initiated from this terminal and the incoming call represents a call terminated at this terminal.

Preferably, one of the attached subscribers may be set to be the default active subscriber.

When a subscriber corresponding to the subscriber identity information of a subscriber identity apparatus is a non-active subscriber, the method to set the subscriber as an active subscriber includes the steps of:

An active instruction is sent to the communication terminal through the subscriber identity apparatus and the active instruction includes the subscriber identity information. The communication terminal receives the active instruction and sets the corresponding subscriber as an active subscriber.

Alternatively, the subscriber selects one of the corresponding attached subscribers as an active subscriber through the operation of the human-machine interface module of the communication terminal. The communication terminal sets the corresponding attached subscriber as an active subscriber according to the active operation instruction of the subscriber.

Preferably, the subscriber identity is authenticated on a communication terminal according to the password inputted by the subscriber. The password is downloaded through the communication service network system when the corresponding subscriber is performing the registration.

When two or more subscribers corresponding to the subscriber identity information are attached to the same communication terminal, the communication terminal sets different use-interface and/or indication information for each corresponding subscriber.

Step 22′: the communication terminal searches in the registered active subscribers in the attached subscriber list stored in the terminal for whether there is an subscriber who corresponds to the identity of the called subscriber in the session request from the network, if there is no matching subscribers, the session request from the network will not be processed; if there is a matching subscriber, the procedure proceeds to step 203.

Step 203: the communication terminal sends a notification in the form of the set information that may differentiate the called subscriber of the session request from the network, specifically the indication information such as the different tones, lights, texts or graphs specified for the called subscriber. One implementation manner is to download the configuration parameters or Java programs from the subscriber home databases such as the HLR or HSS so as to provide different subscribers with different human-machine interfaces.

The human interface and/or indication information are stored at the service network side and are downloaded to the local place by the communication terminal from the service network side when the corresponding subscriber registers at the service network. Or the human interface and/or indication information are set on the local communication terminals.

Though illustration and description of the present invention have been given with reference to preferred embodiments thereof, it should be appreciated by ordinary personnel skilled in the art that various changes in forms and details can be made without deviation from the spirit and scope of this invention as defined by the appended claims.

1. A subscriber identity apparatus for a communication terminal which is connected to a local wireless network system, comprising:
a subscriber identity module for storing subscriber identity information;
a wireless network interface module for accessing the local wireless network system;
a central processing unit connected between the subscriber identity module and the wireless network interface module, for controlling the subscriber identity apparatus to establish communication through the wireless network system with the communication terminal and for sending the identity information to the communication terminal.

2. The subscriber identity apparatus according to claim 1, wherein the subscriber identity module stores corresponding subscriber information which comprises subscriber number, short message, telephone book, key or cryptographic algorithm.

3. The subscriber identity apparatus according to claim 1, wherein the subscriber identity apparatus further comprises a keyboard for inputting a control command and a screen for displaying status information.

4. A communication terminal comprising a central processor and a first interface module for accessing a communication service network, further comprising:
a second interface module for accessing a local wireless network system; wherein
the central processor obtains subscriber identity information through the second interface module, attaches a subscriber corresponding to the identity information and makes the corresponding subscriber communicate with the communication service network through the first interface module and realize communication.

5. The communication terminal according to claim 4, wherein
the communication terminal further comprises an embedded subscriber identity card for storing the subscriber identity information;
the central processor reads the subscriber identity information stored in the embedded subscriber identity card and attaches a subscriber corresponding to the subscriber identity information.

6. The communication terminal according to claim 5, wherein the embedded subscriber identity card is a SIM card, a USIM card or an ISIM card.

7. The communication terminal according to claim 4, wherein the communication terminal supports authentication of the user's subscriber identity through soft SIM, subscriber account number or line authentication.

8. The communication terminal according to claim 4, wherein the communication terminal further comprises a storage for storing the identity information of the attached subscriber and a human-machine interface module, connected to the central processor, for performing human machine interaction.

9. The communication terminal according to claim 8, wherein the central processor comprises:
a communication application control sub-module for controlling the communication;
an attached subscriber management sub-module connected between the communication application control sub-module and the storage or the embedded subscriber identity card, for managing an attached subscriber list;
an active subscriber management sub-module connected between the communication application control sub-module and the storage or the embedded subscriber identity card, for setting one of the attached subscribers as an active subscriber for the communication and storing it in the storage.

10. A communication system comprising a communication service network, at least one communication terminal and at least one subscriber identity apparatus, further comprising:
a local wireless network system for realizing communication between the communication terminal and the subscriber identity apparatus, wherein
the communication terminal obtains subscriber identity information from the subscriber identity apparatus, attaches a subscriber corresponding to the identity information, and makes the corresponding subscriber access the communication service network and realize communication.

11. The communication system according to claim 10, wherein
The subscriber identity apparatus further comprises a subscriber identity module for storing subscriber identity information and
a central processing unit connected between the subscriber identity module and a wireless network interface module of the subscriber identity apparatus, for controlling the subscriber identity apparatus to establish communication with the communication terminal through the local wireless network system and for sending the identity information to the communication terminal.

12. The communication system according to claim 10, wherein the communication terminal further comprises a first interface module for accessing the communication service network, and
a central processor for obtaining the subscriber identity information from the subscriber identity apparatus through a second interface module of the communication terminal, attaching a subscriber corresponding to the identity information, and making the corresponding subscriber access the communication service network through the first interface module and realize communication.

13. The communication system according to claim 12, the communication terminal further comprising:
an embedded subscriber identity card for storing the subscriber identity information; wherein
the central processor reads the subscriber identity information stored in the embedded subscriber identity card and attaches a subscriber corresponding to the subscriber identity information.

14. The communication system according to claim 12, wherein the communication terminal further comprises a storage for storing the identity information of the attached subscriber and a human-machine interface module, connected to the central processor, for performing human-machine interaction.

15. The communication system according to claim 12, wherein the central processor comprises a communication application control sub-module for controlling the communication;
an attached subscriber management sub-module connected between the communication application control sub-module and the storage or the embedded subscriber identity card, for managing an attached subscriber list;
an active subscriber management sub-module connected between the communication application control sub-module and the storage and/or the embedded subscriber identity card, for setting one of the attached subscribers as an active subscriber for the communication and storing it in the storage.

16. A method for attaching a subscriber identity apparatus to a communication terminal, the subscriber identity apparatus and the communication terminal being connected to a local wireless network system respectively and the subscriber identity apparatus storing subscriber identity information, comprising the steps of:
establishing a communication transmission link between the subscriber identity apparatus and the communication terminal through the local wireless network system;
obtaining the subscriber identity information through the communication transmission link and setting a subscriber corresponding to the subscriber identity information to the attached status by the communication terminal.

17. The method according to claim 16, wherein the step of establishing a communication transmission link comprises the steps of:
sending a broadcast inquiry message carrying address information of the subscriber identity apparatus through the local wireless network system by the subscriber identity apparatus,
receiving the broadcast inquiry message through the local wireless network system, and returning an inquiry response message carrying first address information of the communication terminal to the subscriber identity apparatus according to the address information of the subscriber identity apparatus by the communication terminal,
establishing a communication transmission link through the local wireless network system with the communication terminal according to the first address information by the subscriber identity apparatus; or
the step of establishing a communication transmission link comprises the steps of:
sending a broadcast inquiry message carrying first address information of the communication terminal through the local wireless network system by the communication terminal,
receiving the broadcast inquiry message through the local wireless network system, and returning a response message carrying address information of the subscriber identity apparatus to the communication terminal according to the first address information of the communication terminal by the subscriber identity apparatus,
establishing a communication transmission link through the local wireless network system with the subscriber identity apparatus according to the address information of the subscriber identity apparatus by the communication terminal.

18. The method according to claim 16, further comprising the steps of: when the communication transmission link is established between the communication terminal and the subscriber identity apparatus, performing authentication for the subscriber identity apparatus and establishing the communication transmission link with the successfully authenticated subscriber identity apparatus by the communication terminal.

19. The method according to claim 18, wherein
the communication terminal authenticates the subscriber identity apparatus by using a key that is preset in the communication terminal.

20. The method according to claim 16, further comprising the steps of:
establishing communication transmission links with two or more communication terminals at the same time or in time division by the subscriber identity apparatus;
causing the two or more communication terminals to obtain the subscriber identity information respectively;
attaching the subscriber corresponding to the subscriber identity information to the two or more communication terminals.

21. The method according to claim 16, further comprising the steps of:
establishing communication transmission links with two or more subscriber identity apparatuses at the same time or in time division by the communication terminal;
attaching the subscriber corresponding to two or more subscriber identity apparatuses to the communication terminal at the same time after the communication terminal obtains the subscriber identity information from each subscriber identity apparatus respectively.

22. The method according to claim 16, wherein
when the communication transmission link between the subscriber identity apparatus and the communication terminal is interrupted, the communication terminal detaches a subscriber corresponding to a subscriber identity module.

23. A communication control method of a communication terminal for obtaining subscriber identity information from a subscriber identity apparatus through a local wireless network system and attaching a subscriber corresponding to the subscriber identity information, comprising the steps of:
sending a registration request by the communication terminal, which carries the subscriber identity information, communication identity information corresponding to the subscriber and allocated by the communication service network and the communication terminal′ second address information allocated by the communication service network;
correspondingly recording, by the communication service network, the subscriber identity information, the communication identity information corresponding to the subscriber and the second address information of the communication terminal, and processing, by the communication service network, communication of the subscriber corresponding to the subscriber identity information according to the correspondence between the communication identity information of the subscriber and the second address information of the communication terminal.

24. The method according to claim 23, wherein
Steps of the communication terminal obtaining the subscriber identity information from the subscriber identity apparatus through the local wireless network system and attaching a subscriber corresponding to the subscriber identity information further comprise the following steps:
sending a broadcast inquiry message carrying address information of the subscriber identity apparatus through the local wireless network system by the subscriber identity apparatus,
receiving the broadcast inquiry message through the local wireless network system, and returning a response message carrying first address information of the communication terminal to the subscriber identity apparatus according to the address information of the subscriber identity apparatus by the communication terminal, wherein the first address information is allocated by the local wireless network system,
establishing a communication transmission link through the local wireless network system with the communication terminal by the subscriber identity apparatus according to the first address information,
obtaining the subscriber identity information through the communication transmission link and attaching the subscriber corresponding to the subscriber identity information by the communication terminal; or
Steps of the communication terminal obtaining the subscriber identity information from the subscriber identity apparatus through the local wireless network system and attaching a subscriber corresponding to the subscriber identity information, further comprise the following steps:
sending a broadcast inquiry message carrying first address information of the communication terminal through the local wireless network system by the communication terminal,
receiving the broadcast inquiry message through the local wireless network system, and returning a response message carrying address information of the subscriber identity apparatus to the communication terminal according to the first address information of the communication terminal by the subscriber identity apparatus,
establishing a communication transmission link with the subscriber identity apparatus through the local wireless network system according to the address information of the subscriber identity apparatus by the communication terminal,
obtaining the subscriber identity information through the communication transmission link and attaching the subscriber corresponding to the subscriber identity information by the communication terminal.

25. The method according to claim 24, further comprising the steps of:
performing authentication for the subscriber identity apparatus and establishing the communication transmission link with the successfully authenticated subscriber identity apparatus by the communication terminal, when the communication transmission link is established between the and the subscriber identity apparatus.

26. The method according to claim 25, wherein
the communication terminal authenticates the subscriber identity apparatus by using a key that is preset in the communication terminal.

27. The method according to claim 23, further comprising the steps of:
establishing communication transmission links with two or more communication terminals at the same time or in time division by the subscriber identity apparatus;
attaching a subscriber corresponding to the subscriber identity information to the two or more communication terminals after the two or more communication terminals obtain the subscriber identity information respectively.

28. The method according to claim 23, further comprising the steps of:
establishing communication transmission links with two or more subscriber identity apparatuses at the same time or in time division by the communication terminal;
attaching a subscriber corresponding to two or more subscriber identity apparatuses to the communication terminal simultaneously after the communication terminal respectively obtains the subscriber identity information stored in each subscriber identity apparatus.

29. The method according to claim 23, wherein
when the communication transmission link between the subscriber identity apparatus and the communication terminal is interrupted, the communication terminal detaches a subscriber corresponding to a subscriber identity module.

30. The method according to claim 23, further comprising the steps of: reading the subscriber identity information from an embedded SIM card and attaching the corresponding subscriber by the communication terminal.

31. The method according to claim 27, wherein
when a subscriber corresponding to a subscriber identity is attached to two or more communication terminals simultaneously, for the subscriber identity information, the communication service network simultaneously records second address information of the two or more communication terminals and the communication identity information of the subscriber;
the communication service network connects an incoming call carrying the communication identity information of the subscriber to the corresponding communication terminal according to the communication identity information of the called subscriber whose session is ended by the subscriber and the second address information of the communication terminal.

32. The method according to claim 31, wherein
when the communication identity information on two or more communication terminals for a subscriber corresponding to the subscriber identity information is the same, the communication service network connects an incoming call carrying the communication identity information of the subscriber to a plurality of corresponding communication terminals according to the communication identity information of the called subscriber whose session is ended by the subscriber and the second address information of the communication terminals.

33. The method according to claim 28, further comprising the steps of:
when two or more subscribers are attached to the same communication terminal, before an outgoing call is initiated, setting one of the attached subscribers to be an active subscriber and initiating the outgoing call, wherein the call carries the communication identity information of the active subscriber.

34. The method according to claim 33, wherein
when a subscriber corresponding to the subscriber identity information of a subscriber identity apparatus is a non-active subscriber, the step of setting the subscriber to be a active subscriber comprises the steps of:
sending an active instruction comprising the subscriber identity information to the communication terminal through the subscriber identity apparatus,
receiving the active instruction and setting a corresponding subscriber to be an active subscriber by the communication terminal; or
selecting one of the correspondingly attached subscribers as an active subscriber through an operation of a human-machine interface module of the communication terminal by a subscriber, setting the corresponding attached subscriber to be an active subscriber according to the active operation instruction of the subscriber by the communication terminal.

35. The method according to claim 34, wherein when the subscriber sets the subscriber to be an active subscriber through the communication terminal, further comprising the steps of:
the subscriber is authenticated, by the communication terminal, according to the corresponding subscriber password inputted by the subscriber.

36. The method according to claim 35, wherein the subscriber password is downloaded from the communication service network system when the corresponding subscriber registers the subscriber password.

37. The method according to claim 28, wherein when two or more subscribers corresponding to the subscriber identity information are attached to the same communication terminal, the communication terminal sets different interfaces and/or indication information for appropriate subscribers.

38. The method according to claim 37, further comprising:
when the communication terminal receives an incoming call carrying the communication identity information of a subscriber, determining whether there is a corresponding attached subscriber, if yes, connecting the incoming call and indicating the subscriber with corresponding indication information; otherwise, refusing to return a response.

39. The method according to claim 38, wherein
the subscriber interface and/or indication information are stored correspondingly at the service network side and are downloaded to the local place by the communication terminal from the service network side when a corresponding subscriber is registering at the service network; or
the subscriber interface and/or indication information are set in the local communication terminal.
